(19) United States
(12) Patent Application Publication
(10) Pub. No.: US 2023/0061031 A1
(43) Pub. Date: Mar. 2, 2023

(54) SYSTEMS AND METHODS FOR MODULAR CONSTRUCTION ELEMENTS AND INTERCHANGEABLE INSERTS

(71) Applicant: William Michael Hatch, Peoria, AZ (US)

(72) Inventor: William Michael Hatch, Peoria, AZ (US)

(21) Appl. No.: 17/896,310

(22) Filed: Aug. 26, 2022

Related U.S. Application Data
(60) Provisional application No. 63/237,787, filed on Aug. 27, 2021.

(51) Int. Cl. E04F 19/06; E04F 19/04; E04F 13/072; F16B 12/02

(52) U.S. Cl. CPC E04F 19/061; E04F 19/0486; E04F 13/072; F16B 12/02

(57) ABSTRACT

Modular Construction elements are characterized by a variety of profiles and associated interchangeable components and/or inserts. Together, these structures and components allow the end user to incorporate dissimilar or similar materials having a wide range of thicknesses and geometries into a flanged associated with the construction elements and tailored to its particular profile. Through the use of a unique set of interconnection methods and systems, a relatively small set of elements can be arranged to protect the surfaces of a wide array of interior surface treatments and the intersections of those surfaces. Dimensional material can be configured to provide the desired form of intersection and transition type—e.g., horizontally to horizontally, horizontal to vertically, vertical to vertical, vertically to horizontally, and the like—while at the same time creating and maintaining a sealed, sanitary and watertight condition within a specified area.

### REFERENCE TO RELATED APPLICATION

The present application claims priority to U.S. Provisional Patent Application Ser. No. 63/237,787, entitled SYSTEM AND METHODS FOR MODULAR CONSTRUCTION ELEMENTS AND INTERCHANGEABLE INSERTS, filed Aug. 27, 2021, the entire contents of which are hereby incorporated by reference.

### TECHNICAL FIELD

The present invention relates, generally, to construction elements and, more particularly, to a modular construction system with elements that feature a wide variety of interchangeable inserts and profiles.

### BACKGROUND

In the industrial, medical and construction industry, it is often desirable to protect interior surfaces such as walls, floors, and ceilings—and the intersections of these surfaces—from the effects of ecological and biological contaminations, and the like. The goal of such elements is to create sealed, sanitary, and watertight conditions within a defined space and to allow the resulting surfaces and corners to be easily cleaned and maintained. This goal is particularly important in a number of contexts, both residential and commercial, such as warehouses, food processing centers, distilleries, commercial kitchens, walk-in coolers/freezers, restaurants, gyms and fitness centers, hospitals, surgical centers, clean rooms, pharmaceutical processors, urgent care providers, slaughter houses, and retirement/assisted living centers.

Traditionally, commonly known, basic protection is provided by installing finishing elements over existing wall board, sheet rock, plaster, wallpaper, carpeting, vinyl flooring, and other such surfaces. However, presently known methods for protecting interior surfaces and their intersections are highly unsatisfactory in a number of respects. For example, traditional methods involve the use of caulking, glue, staples, nails, and other conventional fastening techniques that may only provide a local or partial seal, and are not effective at protecting the intersecting areas or the interface between large surfaces-edges or connecting points, which may degrade and deform over time. These standard construction techniques are inherently flawed and allow the deleterious elements to accumulate at, behind, or below the surface treatments.

While there have been attempts to address this concern through the development of modular construction elements, such systems still remain unsatisfactory. For example, known construction element systems are generally limited to use with simple surface geometries (e.g., wall/floor intersections), and are unable to accommodate the special problems posed by architectural needs or features typical in modern buildings, such as base boards, columns, doors, windows, chair/bumper rails, and the like. Furthermore, these modular systems are not flexible with respect due to their applications, interconnect methods and geometries, and cannot easily be adapted to the special or even basic requirements of a particular site.

Accordingly, new systems and methods are therefore needed to overcome these and other limitations of prior art construction elements and/or related systems. to facilitate a transitioned surface that prevents or limits the fore mentioned deleterious elements from contacting, growing or accumulating behind the underlying surfaces at these intersections.

### SUMMARY OF THE INVENTION

Various embodiments of the present invention relate to the novel use of construction elements characterized by a variety of “elements and profiles” and the associated interchangeable components/inserts. Together, these structures and components allow the end user to incorporate dissimilar or similar materials having a wide range of thicknesses and geometries into a “flanged or insertable-receiving area” behind, on, or under the otherwise integrated components with respect to the desired profile. In additional, through the use of a unique set of interconnection methods, a relatively small set of elements can be arranged to protect the surfaces of a wide array of interior or exterior surface treatments and the intersections of those surfaces.

In accordance with one aspect of the invention, a construction element system includes a construction element body configured to transition between a first surface (e.g., a floor) and a second surface (e.g., a wall) having a defined intersection thereby, wherein the construction element body includes at least one flanged insertable-receiving area and a surface profile. The system further includes at least one interchangeable insert configured to removably interface with the flanged area of the construction element body.

The modular systems and methods described herein can be used in conjunction with any desired “dimensional material” and can be configured to provide the desired form of intersection and transition type—e.g., horizontally to horizontally, horizontal to vertically, vertical to vertical, vertically to horizontally, and the like—while at the same time creating and maintaining a sealed, sanitary and watertight condition within a specified area.

As is commonly known in the art, dimensional materials come in a wide variety of types, materials, and thicknesses, including, without limitation, to wall coverings (e.g., wallpaper, plastics, metals, glass, FRP, stainless steel, honeycombed panels, tile, solid surface materials, planking, boards, drywall and any other commonly used architectural elements) and floor coverings (e.g., vinyl flooring, VCT, tile, granite, marble, wood, carpet, concrete, epoxy, metal or fiberglass grating, and the like).

Furthermore, as described in further detail below, the present invention contemplates a variety of commonly used and/or themed profiles, including, but not limited to: baseboards, chair rails, crown moldings, corner guards, wall end-caps, bumper/crash rails, door and window frame assemblies, pass-throughs, handrails, architectural and transitional elements, wiring/data/plumbing chases, security enclosures, roller-shade housings, and the like.

The components and inserts described herein may formed using any desired manufacturing technique and a wide range of materials, for example: extruded, pultruded, injected, die-cast, or molded forms comprising one or more of: aluminum, plastics, vinyl, ABS, PVC, FRP, and other common or special use materials and composites.

### BRIEF DESCRIPTION OF THE DRAWING FIGURES

The present invention will hereinafter be described in conjunction with the following drawings:

FIG. 1 is a side view of an element shown as a baseboard profile in accordance with one embodiment, and illustrates some of the various features incorporated into many elements illustrated throughout this application;

FIGS. 2(a)-(f) are side views of a variety of example 6-inch baseboard, chair/crash rail profiles and associated base types;

FIG. 3(a) is a side view, and FIGS. 3(b)-(c) are isometric views, of an example 6-inch riser cove base;

FIGS. 4(a)-(f) are side views of a variety of example 4-inch baseboard profiles with interchangeable/stackable sections of components/profiles;

FIGS. 5(a)-(d) are various views of a 4-inch element having a straight base profile;

FIGS. 6(a)-(b) are isometric and side views, respectively, of a 6-inch element with a coved baseboard profile configured to accept a wire chase component in its central, multi-use area;

FIGS. 7(a)-(d) are various views of a 4-inch chair crash rail/bumper rail element;

FIGS. 8(a)-(d) illustrate an alternate 4-inch chair crash rail/bumper rail element featuring a straight base;

FIGS. 9(a)-(e) are various views of example quick cleat components;

FIGS. 10(a)-(b) are isometric and side views, respectively, of an example upper-flange interconnect component;

FIGS. 11(a)-(b) are isometric and side views, respectively, of an example mid-flange interconnect component;

FIGS. 12(a)-(e) are side views of example upper flange interconnects having a variety of lateral dimensions;

FIGS. 13(a)-(e) are side views of example mid-flange interconnects having a variety of lateral dimensions;

FIGS. 14(a)-(f) are various views of example lower flange interconnects having a variety of vertical dimensions and radial components;

FIG. 15 illustrates just one installation example of an element with a baseboard profile being secured to a wall and substrate, including placement of an upper flange interconnect component, a mid-flange interconnect component, and adhesive;

FIGS. 16(a)-(b) are side views of example 4-inch elements with antiligature handrail profiles and wall extensions;

FIGS. 17(a)-(b) are side views of example 6-inch elements with antiligature handrail profiles and wall extensions;

FIG. 18 is a side (or top) view of a series of interlocking column wrap/chase elements and wall extensions;

FIGS. 19(a)-(f) are side views of adjustable/interchangeable crash/rub/chair rail elements and extensions;

FIGS. 20(a)-(c) illustrate a range of example door/window/wall-frame elements;

FIGS. 21(a)-(b) are isometric views of example inside/outside corner guard elements;

FIGS. 22(a)-(d) are side views depicting, sequentially, the insertion of a hinged component into a flange interconnect element;

FIG. 23 includes side views of variable height/width inserts for lens covers, a back cover for a wire chase (or tray for an LED assembly), as well as example modular interconnectable profile elements;

FIG. 24(a)-(d) illustrates, for various interconnectable profiles, the insertion of a wire chase component into a multi-use area created via an insert such as that shown in FIG. 23;

FIG. 25(a)-(d) illustrates, for various interconnectable base profiles, the insertion of a wire chase component into a multi-use area created via an insert such as that shown in FIG. 23;

FIG. 26 illustrates an example tapered break-away plastic pin assembly in accordance with one embodiment;

FIGS. 27(a)-(j) illustrate interchangeable flange with various lateral dimension examples in accordance with various embodiments;

FIGS. 28(a)-(d) illustrate, respectively, cap molding with an interchangeable flange, divider molding with an interchangeable flange, an inside corner molding with an interchangeable flange, and an outside corner configuration;

FIGS. 29(a)-(e) illustrate riser cove bases with interchangeable riser heights with various vertical dimensions;

FIGS. 30(a)-(d), 31(a)-(i), 32(a)-(1) illustrate a variety of snap trim features and examples having a range of shapes, sizes, and configurations;

FIG. 33 illustrates another installation example in which flooring (e.g., carpet or tile) is coupled to the floor/substrate with a baseboard profile element being secured to a wall and substrate, including placement of an upper flange interconnect component, a mid-flange interconnect component, and adhesive;

FIGS. 34(a) and (b) illustrate the use of a lower flange riser extension of various vertical dimensions in accordance with one cove base example.

### DETAILED DESCRIPTION OF PREFERRED EXEMPLARY EMBODIMENTS

The present subject matter relates to improved systems, methods for construction elements and interchangeable inserts that can be assembled to protect floors, walls, and a variety of other interior or exterior surfaces. It will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to construction elements, flooring, wall construction, manufacturing techniques, and the like need not be described herein.

As a preliminary matter, in the interest of brevity the term “profile” may be used herein to refer to either the cross-sectional shape of an element, or as the element itself. Thus, for example, a component might be described as an “element with a baseboard profile” or, more simply, a “baseboard profile” or “element”. Furthermore, it will be understood that the drawings are representations and are not necessarily drawn to scale, and that the relative dimensions of the components are not intended to limit the invention in any way.

In accordance with one aspect of the invention, a construction element system includes: (1) a construction element body configured to transition between a first surface (e.g., a floor) and a second surface (e.g., a wall) having an intersection defined thereby, wherein the construction element body includes an insertable-receiving flanged area and a surface profile; and (2) at least one interchangeable insert configured to removably interface with the flanged area of the construction element body.

In one embodiment, the construction element body is dimensional material formed at a predetermined length. The construction element body may include multiple, discrete sections of dimensional material longitudinally joined at their respective ends. For example, the sections may be joined by longitudinal pins inserted within pin openings provided at the respective ends.

As described in greater detail below, surface profile may include one or more baseboards, chair rails, crown moldings, corner guards, end-caps, bumper rails, door frame components, window frame components, pass-throughs, hand-rails, architectural and transitional elements, chases, security enclosures, and similar structures.

The construction element system may include a back component configured to be securely coupled to the first surface and removably coupled via an interconnect structure to the flange area of the construction element body. For example, the interconnect structure may include a first projection and a second projection, each configured to be elastically deformed and inserted into a receiving keyway incorporated into the flanged area. In another embodiment, the interconnect structure includes a single cleat projection configured to be inserted into a receiving keyway incorporated into the flanged area.

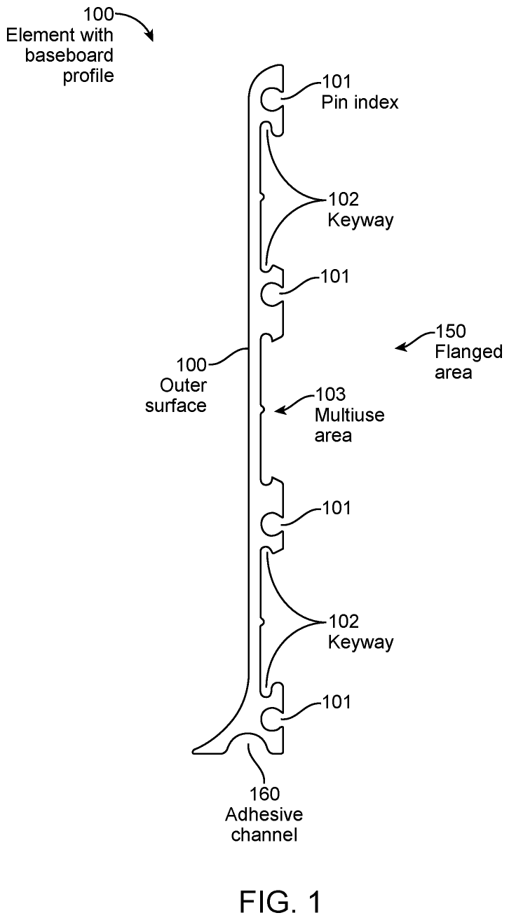

Referring now to FIG. 1, certain common features of the present invention will now be described in the context of a particular example element, i.e., an element having a coved baseboard profile as shown. More particularly, the profile 100 in this example generally includes a series of four pin indexes 101 distributed vertically (in this case, equidistantly) with a set of interior regions defined therebetween—i.e., a keyways 102 and a central multi-use area 103. Profile 100 also includes a concave adhesive channel 160 facing downward (at its “foot”), and an outer surface that generally faces inward, and is exposed to the environment. It will be understood that FIG. 1 presents a cross-sectional view, and that profile 100 may have any desired length or radial variations (i.e., along the dimension extending into the page).

The phrase “flanged area” (150) is used to refer to the region or regions defined “behind” the outer surface of profile 100 (including, for example, keyways 102 and multiuse area 103). Stated another way, flanged area 150 defines one or more open regions/volumes along the backside of profile 100, which (when installed) will generally be mounted in contact with a wall or other vertical surface (not shown in FIG. 1). As described in further detail below, the flanged area 150 provides opportunities for added functionality, in the form of securing a varietal of different attachments or fixtures/fixing methods, chaseways, within the flanged area and the like. The phrase “insertable-receiving” when used in connection with the flanged area generally means a region and/or features configured to receive an insert or other component.

In the illustrated embodiment, the pin indexes 101 have the cross-sectional form of a circle with a clipped edge (which appear as a rectangular opening when the flanged area is viewed head-on). The invention is not so limited, however, and any shape or configuration capable of accepting a properly dimensioned pin may be employed. Similarly, keyways 102 are shown with upper and lower indentations configured to receive corresponding cleats (as described in further detail below), but may have a variety of shapes, depending upon the particular application.

Having thus described certain common features of the invention in the context of an example baseboard profile, a variety of embodiments, elements, profiles, and interchangeable inserts will now be described.

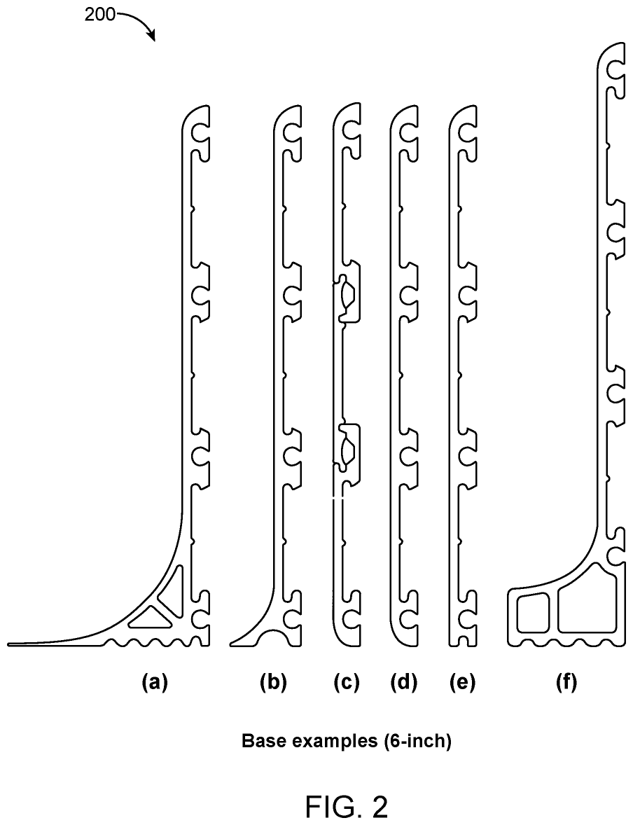

FIGS. 2(a)-(f) are side views of a variety of example six-inch baseboard profiles and associated base types. In each case, the outer surface of the profile faces toward the left, and the corresponding flanged area faces the right. illustrated are examples of (a) an extended cove base, (b) a standard cove base, (c) a chair/crash rail (with a central insert), (d) a chair/crash rail, (e) a straight base, and (f) a riser cove base. As shown, FIG. 2(c) illustrates an example in which the profile consists of three separate components: an upper portion, a bottom portion, and a central portion linking the two by way of opposing cleats that together also form openings for pin insertion. Any of the examples shown in FIG. 2 may incorporate this central insert in alternate embodiments.

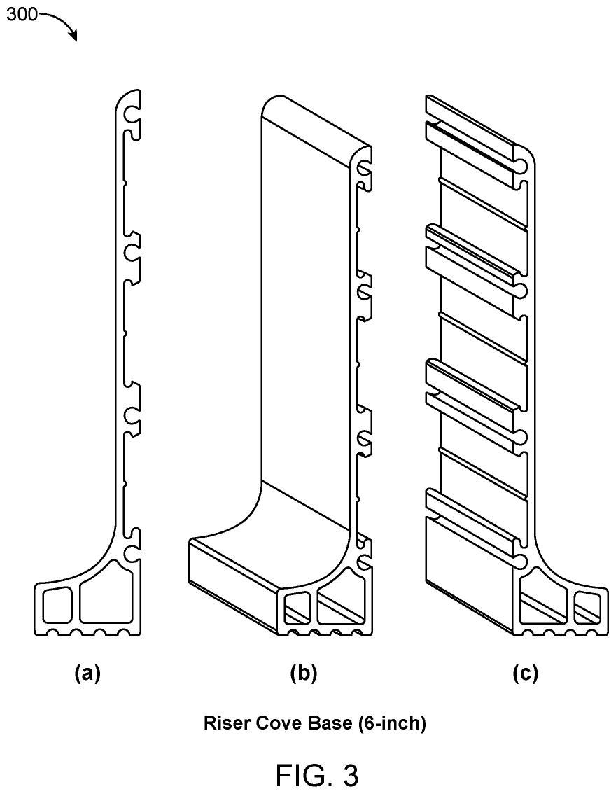

FIG. 3(a) is a side view, and FIGS. 3(b)-(c) are isometric views, of an example 6-inch riser cove base 300. That is, the embodiment shown in FIG. 3 corresponds, generally, to FIG. 2(f), and illustrates how the various features extend laterally along the length of the element. but not limited to the flanged area. The riser base shown in FIG. 3 may have a variety of dimensions, but its primary purpose is to provide a vertical extension of the element, as might be required in a particular embodiment.

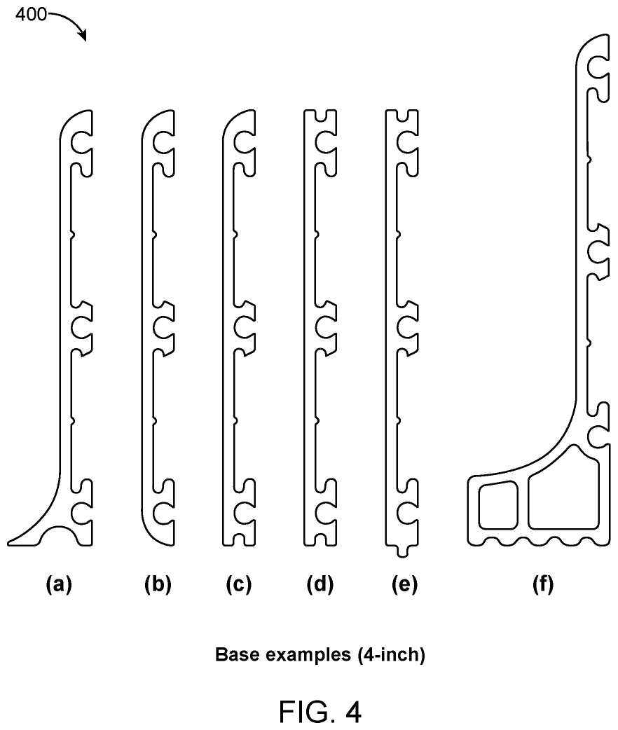

FIGS. 4(a)-(f) are side views of a variety of example 4-inch baseboard profiles 400. illustrated are examples of (a) a cove base, (b) a chair/crash rail, (c) a straight base, (d) a straight or mid-section of base accompanied by a corresponding straight mirrored upper and lower surface, (e) a straight or midsection of a base accompanied by a projecting, bottom tongue and an upper grooved (T&G) feature, and (f) a riser cove base. The projection at the bottom of the element of FIG. 4(e) is configured to fit—in a tongue-in-groove fashion—into the corresponding opening at the top or bottom of another element (i.e., the groove shown in FIG. 4(d)).

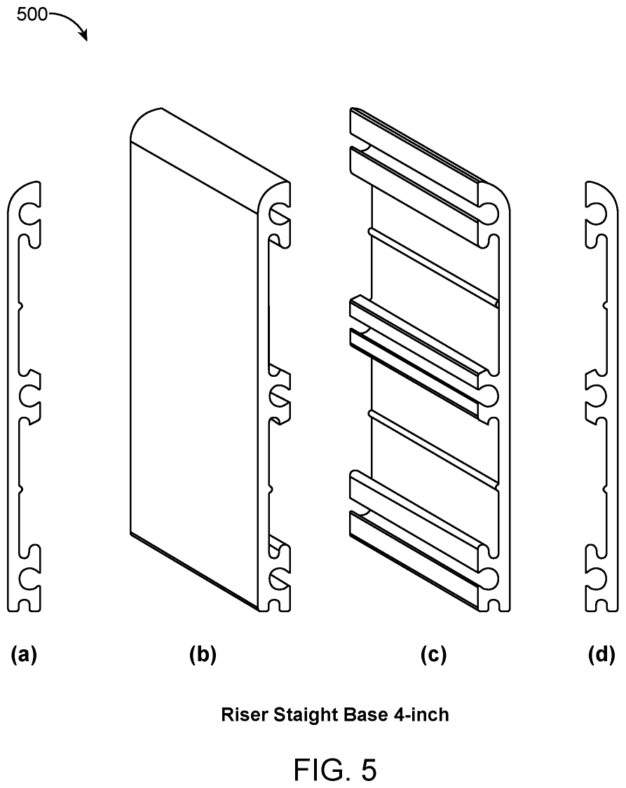

FIGS. 5(a)-(d) are various views of a 4-inch element 500 having a straight base profile. That is, FIGS. 5(a) and 5(d) are opposing cross-sectional views, and FIGS. 5(b) and 5(c) are opposing isometric views of the element (which corresponds to the element of FIG. 4(c)).

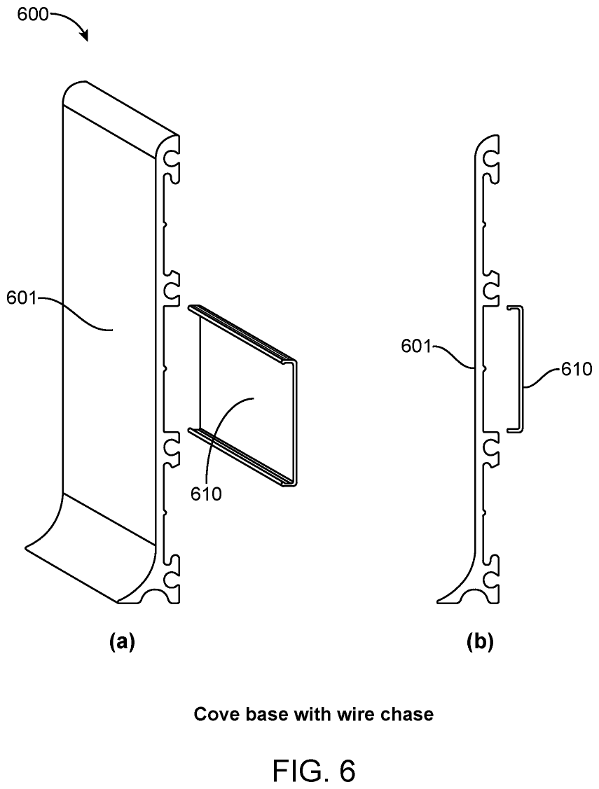

FIGS. 6(a)-(b) are isometric and side views, respectively, of a 6-inch element 600 with a coved baseboard profile configured to accept a wire chase component 610 in its central, multi-use area. That is, chase 610 is a generally planar component having upper and lower edge extensions configured to form a compression or spring fit within the generally rectangular multi-use area, as shown. The primary purpose of chase 610 is to encapsulate and protect wires or other components so that they are safely enclosed and insulated from the wall and surrounding elements (not shown). Chase 610 may be fabricated using any of the materials and profiles generally cited above for the various components.

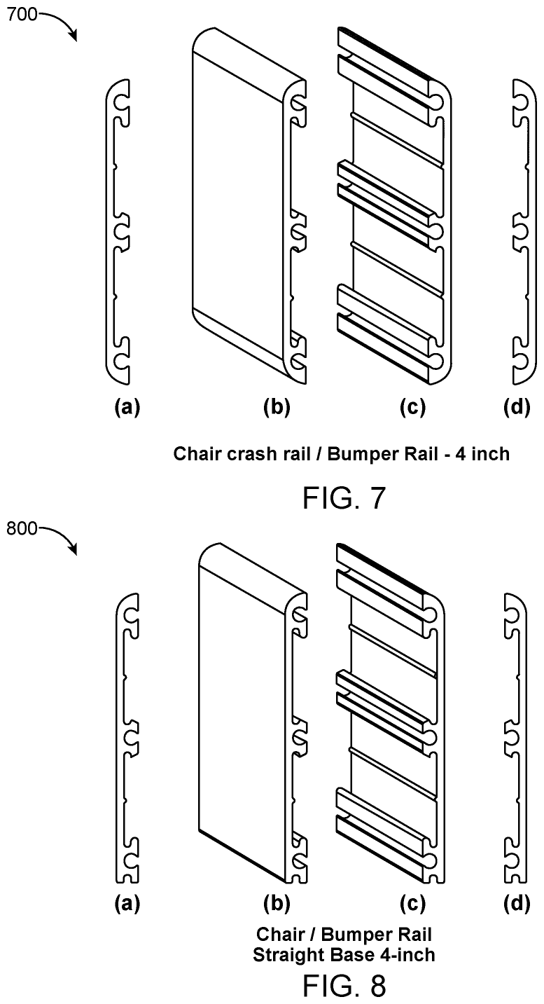

FIGS. 7(a)-(d) are various views of a 4-inch chair/crash rail/bumper rail element 700, and FIGS. 8(a)-(d) illustrate an alternate 4-inch chair/crash rail/bumper rail element 800 featuring a straight base, as shown. In some embodiments, chair rail 800 is used to protect the bottom portion of a wall where it intersects with the floor, and chair rail 700 is used to protect the wall at a height that is substantially the same as the chairs or other furniture used in the environment.

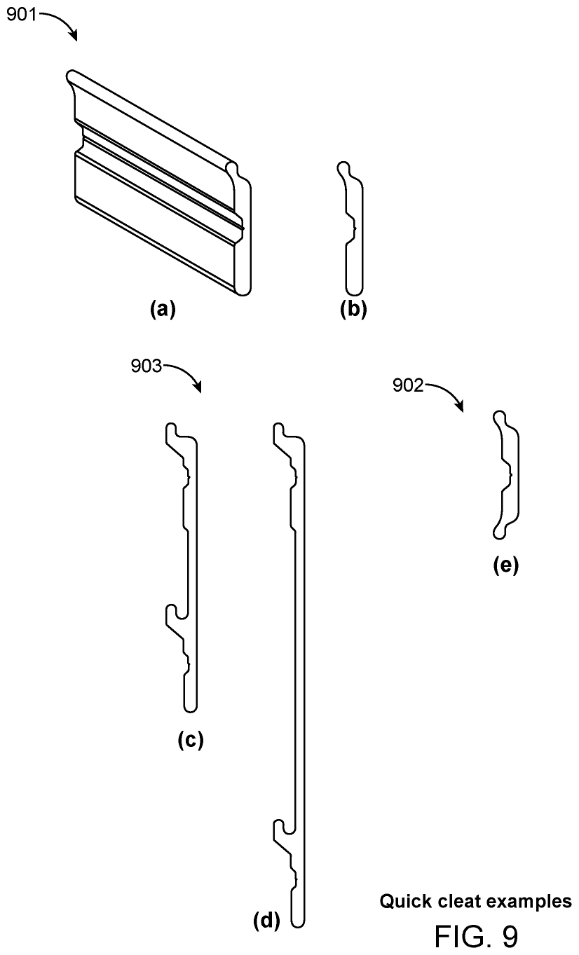

FIGS. 9(a)-(e) are various views of example quick cleat components used to secure the profile elements (such as those shown in FIGS. 1-8) to a wall or other vertical surface. In each case, the cleat is configured to fit within a corresponding keyway of the element to which it is attached. More particularly, FIGS. 9(a) and 9(b) illustrate isometric and side views of a simple top cleat component 901, FIG. 9(e) illustrates a side view of a double cleat component 902 configured to attach at both its top and bottom within a given keyway, and FIGS. 9(c) and 9(d) illustrate cleat designs 903 configured to attach to separate keyways that are separated by a given vertical distance.

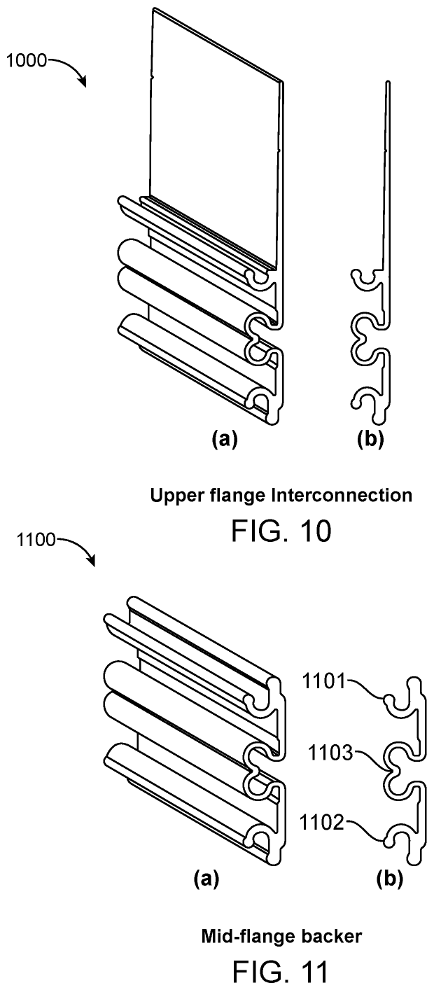

FIGS. 10(a)-(b) are isometric and side views, respectively, of an example upper-flange interconnect component 1000. In general flange 1000 is configured to fit within an upper keyway of the flange region to form an aesthetically pleasing transition to the vertical surface itself while providing an offset relief area between the base and the wall to accept/insert wall coverings or other materials as previously described. Similarly, FIGS. 11(a)-(b) are isometric and side views, respectively, of an example mid-flange interconnect component 1100.

With continued reference to the mid-flange backer shown in FIG. 11, it can be seen that, in cross-section, each has an upper and lower projection (1101, 1102) configured to fit within corresponding grooves in a keyway. In a preferred embodiment, these interconnections have a distinctive, heart-shaped region 1103 that allows elastic deformation both vertically (i.e., compression along the vertical axis) and rotationally (i.e., such that the structure can be bent to fit within the corresponding keyway).

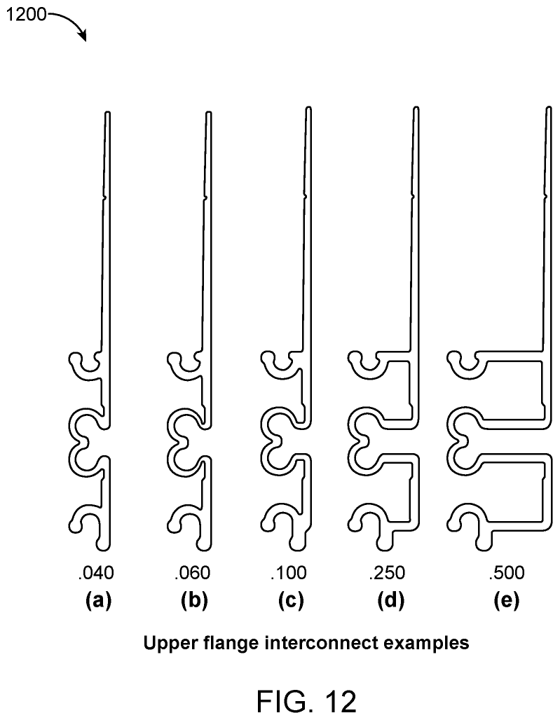

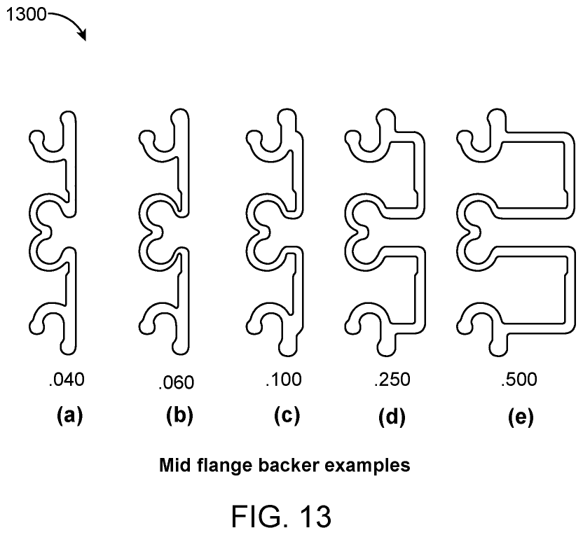

FIGS. 12(a)-(e) are side views of example upper flange interconnects 1200 having a variety of lateral dimensions. That is, the figures illustrate upper flange interconnects with lateral dimensions of 0.04, 0.06, 0.1, 0.25, and 0.5 inches, respectively. This allows the flange to be used in connection with the insertion or reception of other elements that may need to project a given distance from the wall or other vertical surface. Similarly, FIGS. 13(a)-(e) are side views of example mid-flange interconnects 1300 having a variety of lateral dimensions. As with the embodiments shown in FIG. 12, each of these designs allows an element to positioned at the desired set-off distance from a wall or other vertical surface. Similarly, FIGS. 13(a)-(e) illustrate side views of example mid-flange backer interconnects 1300 having a variety of lateral dimensions.

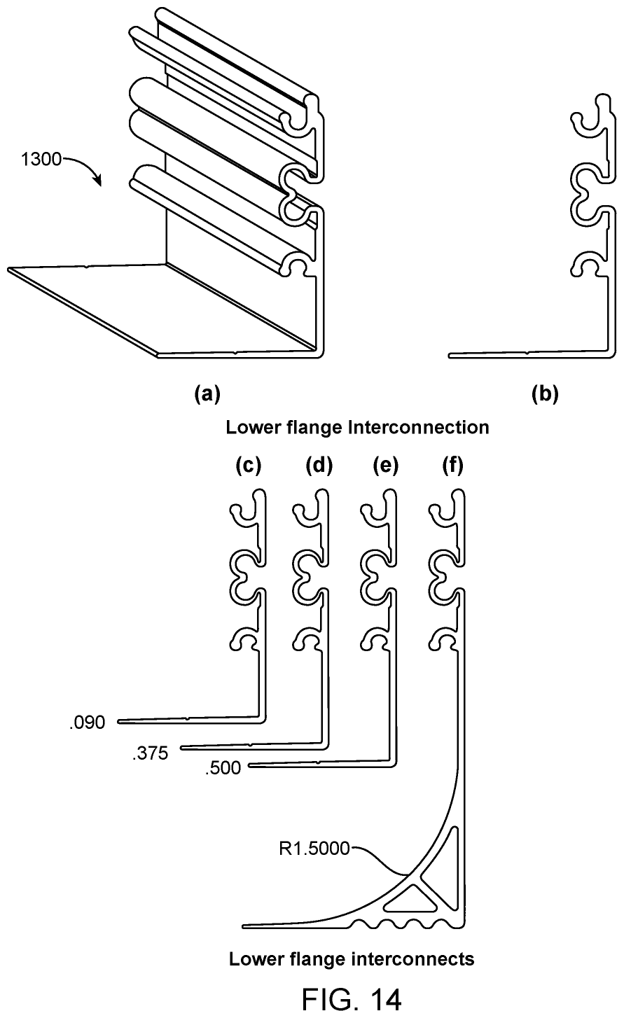

FIGS. 14(a)-(f) are various views of example lower flange interconnect components, which include features similar to those described and shown above in FIGS. 12-13. FIGS. 14(c)-(e) illustrate different vertical height set-offs (from the floor or other horizontal surface), and FIG. 14(f) shows a lower flange interconnect with a larger radius of curvature, which may be desirable in some scenarios. For example, this form of interconnect may be used for a coved sheet vinyl installation in lieu of a two-piece cove stick and J-trim. It is designed to seamlessly integrate the floor and wall along with the base to eliminate what is typically a poor transition that is prone to failure, and can be a health issue because it is an often overlook area when cleaning.

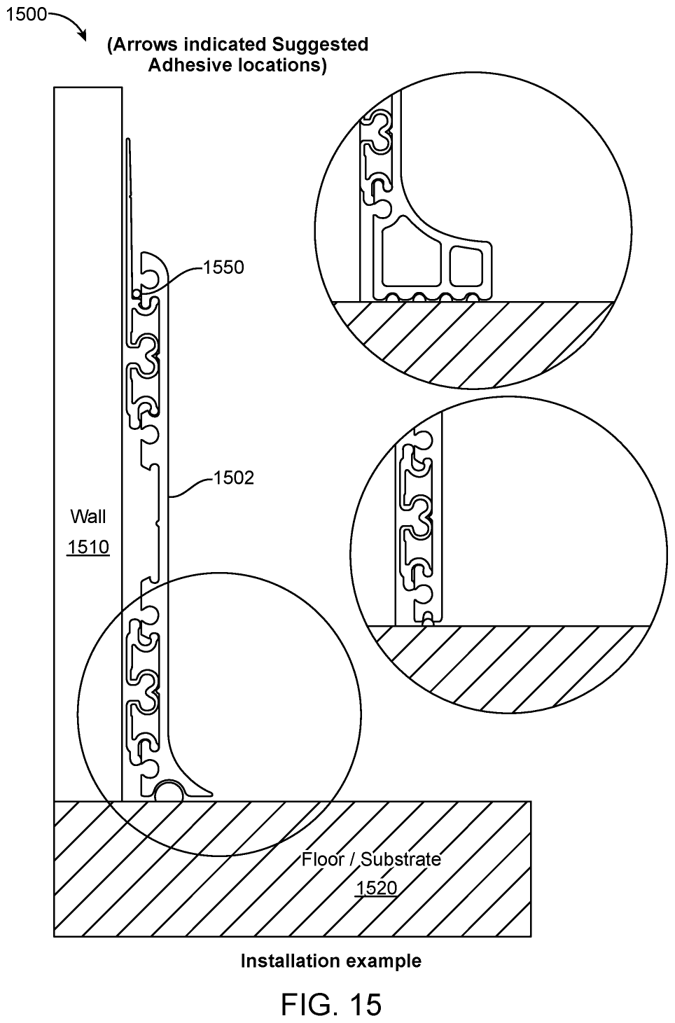

FIG. 15 illustrates just one installation example 1500 of an element with a baseboard profile being secured to a wall and substrate, including placement of an upper flange interconnect component, a mid-flange interconnect component, and adhesive. That is, FIG. 15 illustrates a baseboard element 1502 secured to wall 1510 and a floor/substrate 1520 via upper and lower flange components as shown. Suggested adhesive locations are indicated by arrows (e.g., 1550). In the main drawing, a single portion of adhesive is shown within the concavity at the bottom of element 1502. However, depending upon the nature of the profile, it might be advantageous to place multiple “beads” or portions of adhesive (as shown in the top inset drawing with the riser base), or at a single, small location (as shown in the bottom inset drawing with the straight base). It will be appreciated that the adhesive locations shown in the drawing are not intended to be limiting, and that a wide variety of adhesives, tapes, microsealants and or other attachment techniques/methods may be used.

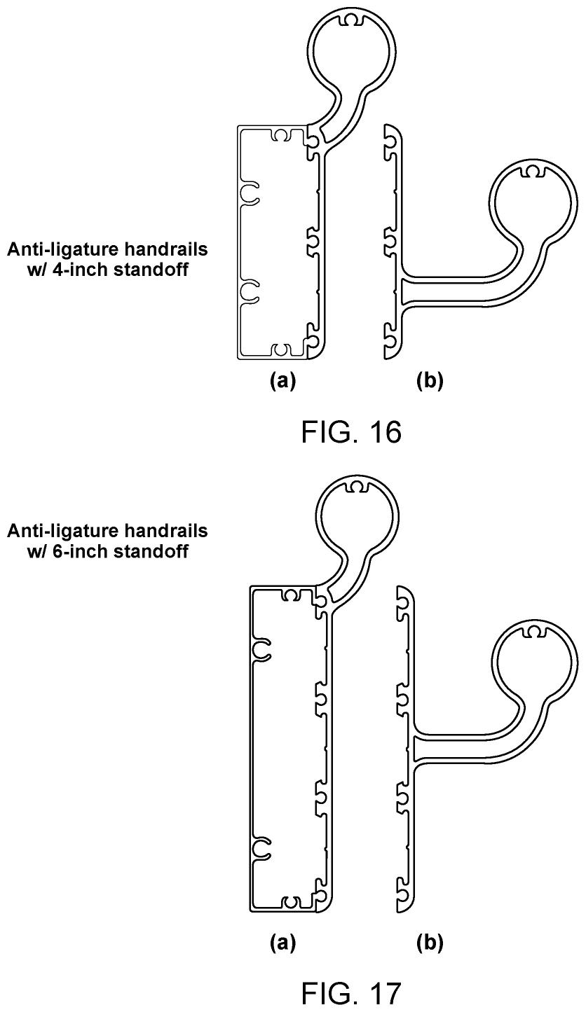

FIGS. 16(a)-(b) are side views of example 4-inch elements with antiligature handrail profiles and wall standoff/extensions, and FIGS. 17(a)-(b) are side views of example 6-inch elements with antiligature handrail profiles and wall standoff/extensions. That is, in some contexts it is desirable to provide handrails that do not allow a rope, length of fabric, cord, or other such object to be secured to it in a way that would pose a danger to individuals. In such cases, embodiments as shown in these figures may be used. In each case, the profile is characterized by a handrail portion integral with a vertical chair/crash rail portion, wherein the pin openings are distributed as shown. The handrail may extend from the upper corner of the profile (e.g., FIGS. 16(a) and 17(a)) or from near the center of the profile (e.g., FIGS. 16(b) and 17(b)), with or without a wall offset/standoff.

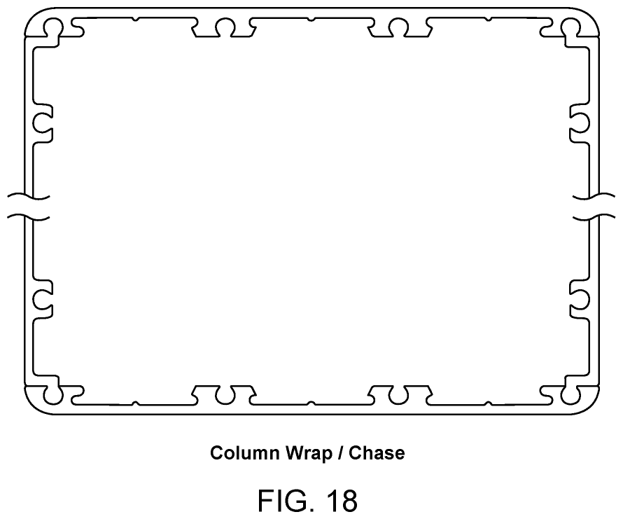

FIG. 18 is a side (or top) view of a series of interlocking column wrap/chase elements in accordance with various embodiments. That is, viewed from the top, this set of profiles can wrap around or create a central rectangular column or other structure. These interlocking features can comprise a variety of functions not shown, including but not limited to hinge, slide, or snap joints.

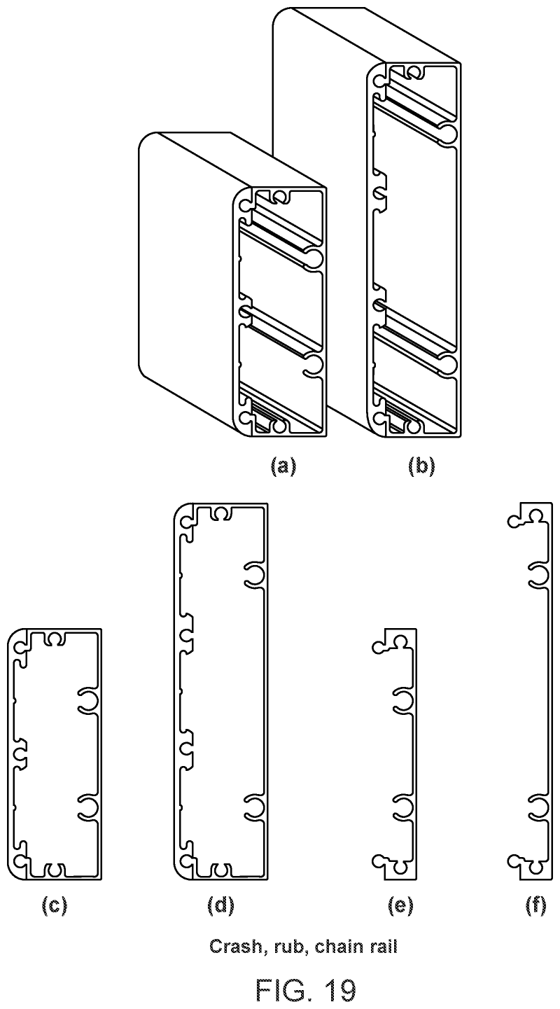

FIGS. 19(a)-(f) are various views of example crash/rub/chair rails. FIGS. 19(c) and (d) show, in cross-section, how a pair of elements can be connected to extend a given distance from the wall or other vertical surface. FIGS. 19(e) and 19(f) show single profiles (without the corresponding crash-surface component) that may be used when the required distance from the wall is relatively small.

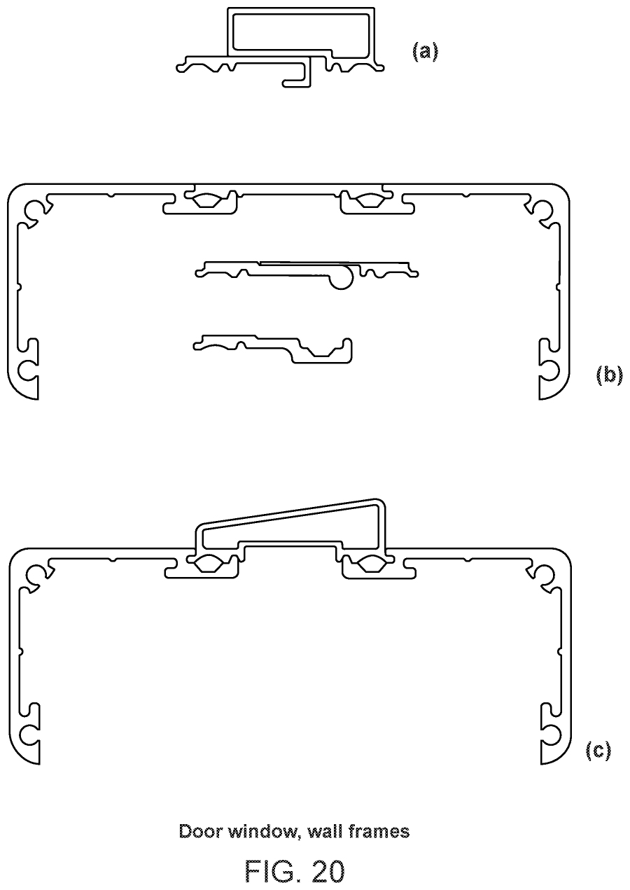

FIGS. 20(a)-(c) illustrate example door/window/wall-frame elements, which have the ability to accommodate or create any desired dimension, with the middle section being sized accordingly or adjustable as shown in the midsection of (b). Additionally, this area could be a fixed (c) or adjustable (b) or as a door/window stop (a) of any profile, fixed or adjustable.

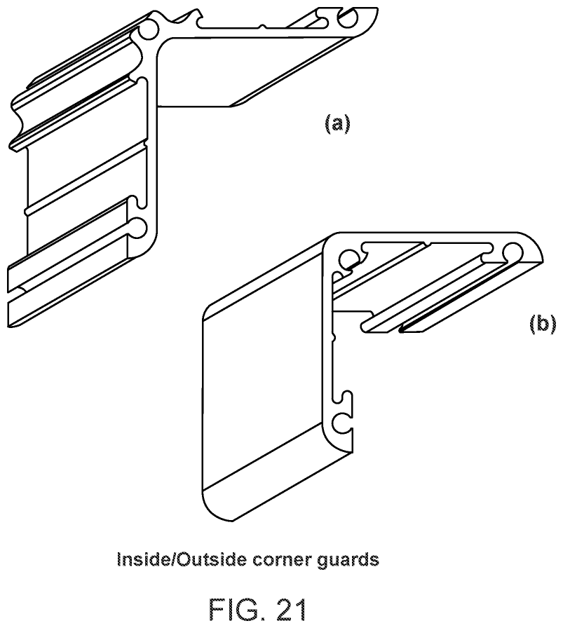

FIGS. 21(a)-(b) are isometric views of example inside/outside corner guard elements. That is, FIG. 20(a) illustrates an inner corner guard, and FIG. 20(b) illustrates an outer corner guard element. Note that these elements can accept any of the flange or transition elements described here, just like the base elements.

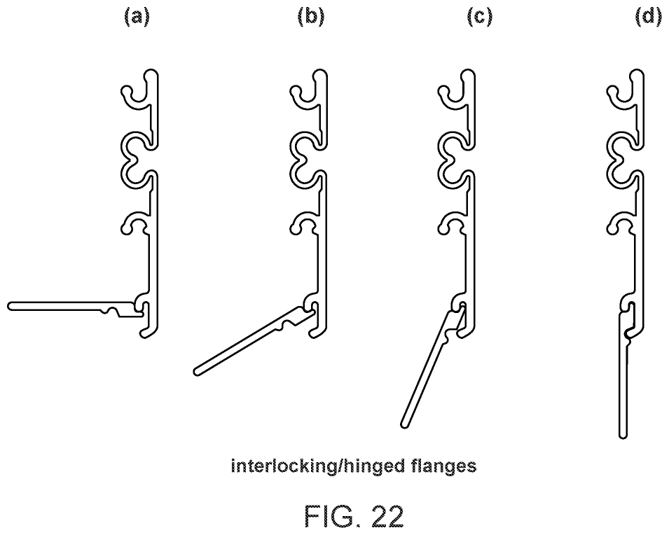

In accordance with another novel feature of the present invention, flanges may allow elements to be easily rotated into place to secure them to their matching flanges. FIGS. 22(a)-(d), for example, are side views depicting, sequentially, the insertion of a hinged component into a flange interconnect element. At step (a), the element is placed nearly orthogonal to the flange component, it is then rotated (counter-clockwise in the figures) so that, through steps (b)-(d), the element is substantially parallel with the flange component. It will be appreciated that this interlock method has significant advantages over prior art systems, which are typically difficult and time-consuming to assemble. Note that the hinged element can be configured with any profile or feature shown or not shown.

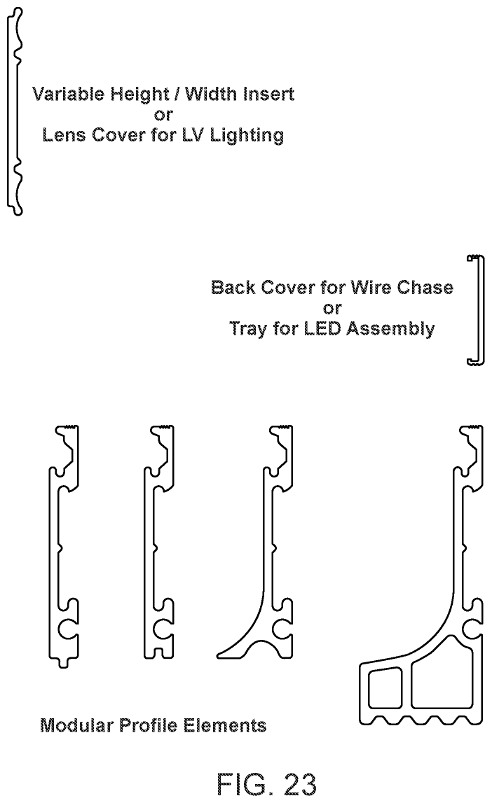

FIG. 23 includes side views of variable height/width inserts for lens covers, a back cover for a wire chase (or tray for an LED assembly), as well as example of interconnectable modular profile with hinged and tongue and groove elements. These components interface with corresponding keyways and/or multi-use areas, depending upon context.

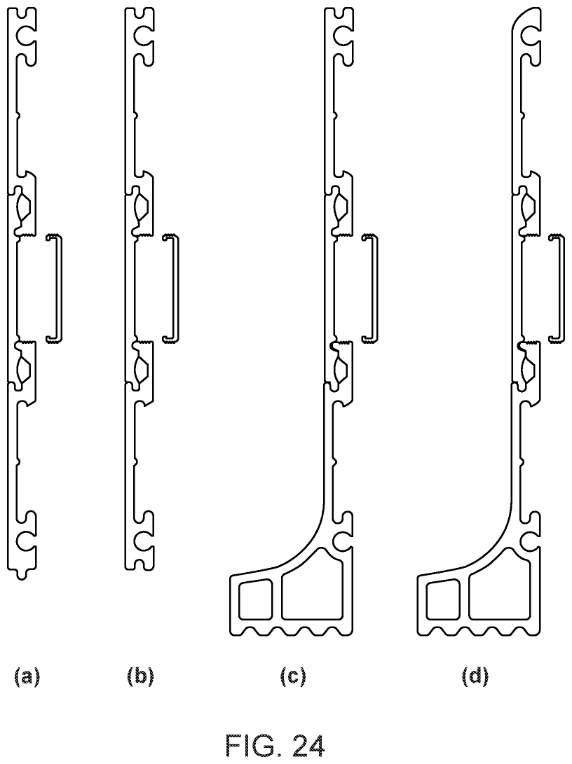

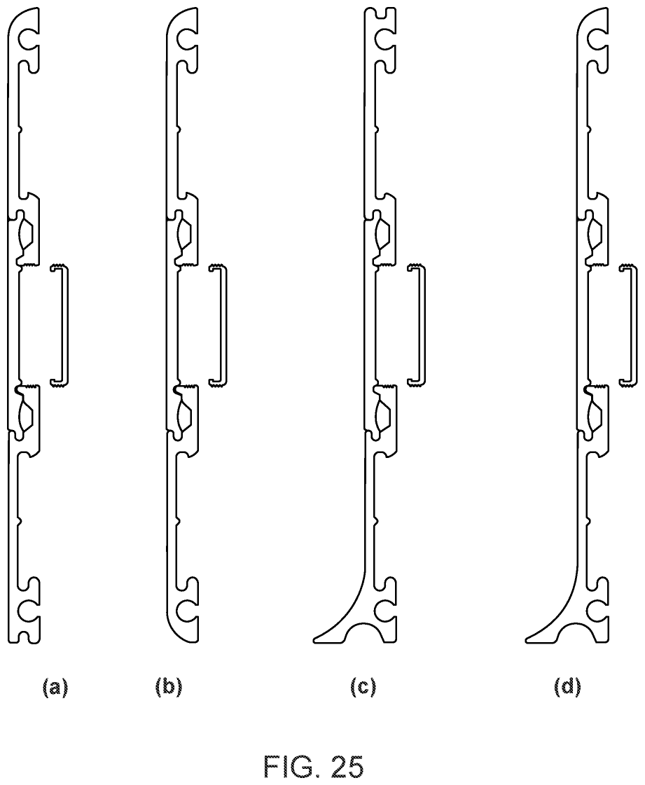

FIG. 24 illustrates, for various profiles with a hinged component, the insertion of a wire chase component into a multi-use area created via an insert such as that shown in FIG. 23. Similarly, FIG. 25 illustrates, for various base profiles, the insertion of a wire chase component into a multi-use area created via an insert such as that shown in FIG. 23. In each case, a central hinged center element is inserted between the upper and lower elements, thereby providing a vertical space in which to insert the wire chase element.

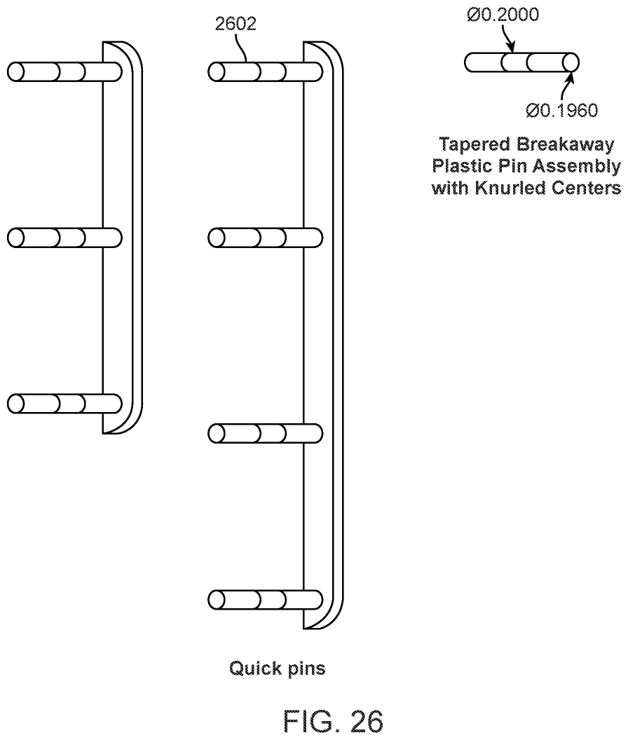

FIG. 26 illustrates an example tapered break-away plastic pin assembly in accordance with one embodiment. It will be appreciated that a variety of pins may be used in conjunction with the present invention. In a preferred embodiment, as shown, the pins are knurled in their central regions, and have an outer diameter of about 0.2 inches (wherein the knurled region is slightly higher). As shown, the “quick pin” assembly may include a series of equidistant pins attached frangibly via one end to a common spine or the like. The pins may be spaced in accordance with the pin opening spacing of the corresponding profile. This feature speeds up assembly, as it does not require the assembler to select insert individual pins.

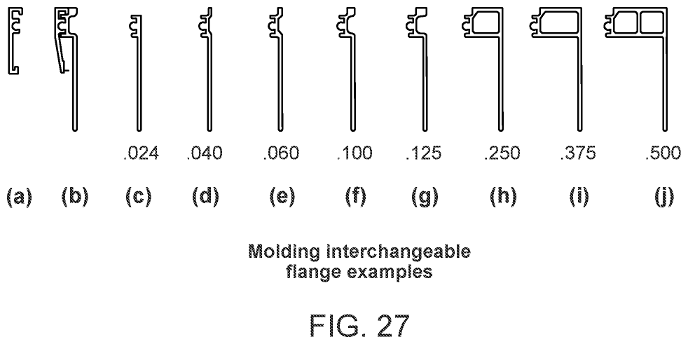

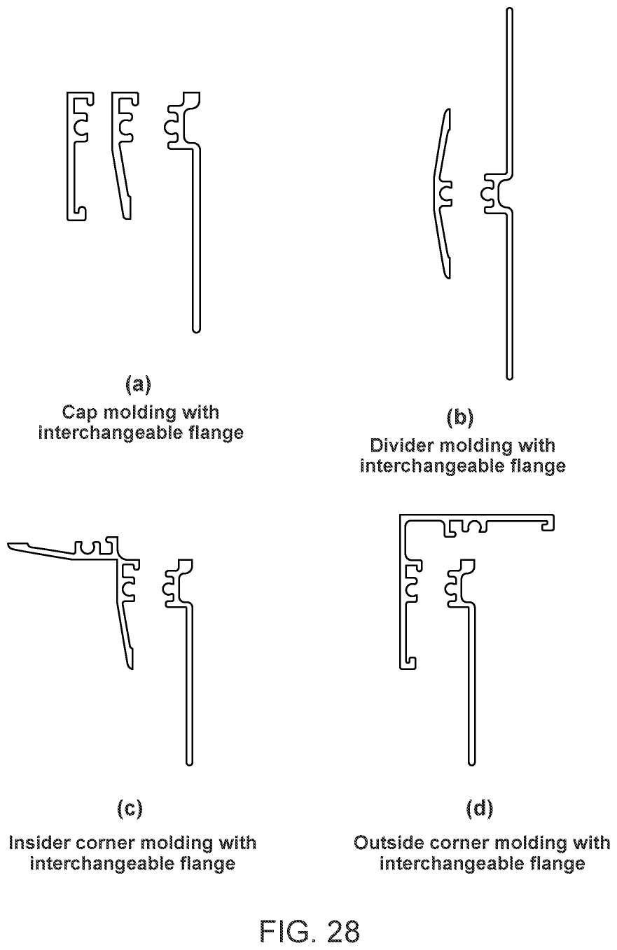

FIGS. 27(a)-(j) illustrate interchangeable flange examples in accordance with various embodiments. That is, each includes an upper three-pronged portion that accepts and securely interfaces with a corresponding element (shown in FIG. 22(a)). As with the flange components, a variety of lateral dimensions may be provided (in this example, ranging from 0.24 inches to 0.5 inches). This figure shows (a) Cap Trim (b) different profile of Cap Trim with flange Note: these flanges are for Trim.

FIGS. 28(a)-(d) illustrate, respectively, configurations of, cap molding with an interchangeable flange (FIG. 28(a)), divider molding with an interchangeable flange (FIG. 28(b)), an inside corner molding with an interchangeable flange (FIG. 28(c)), and an outside corner (FIG. 28(d)). As shown, the molding and flange elements are configured to provide a compression fit via a substantially circular element and an elastically deformable opening.

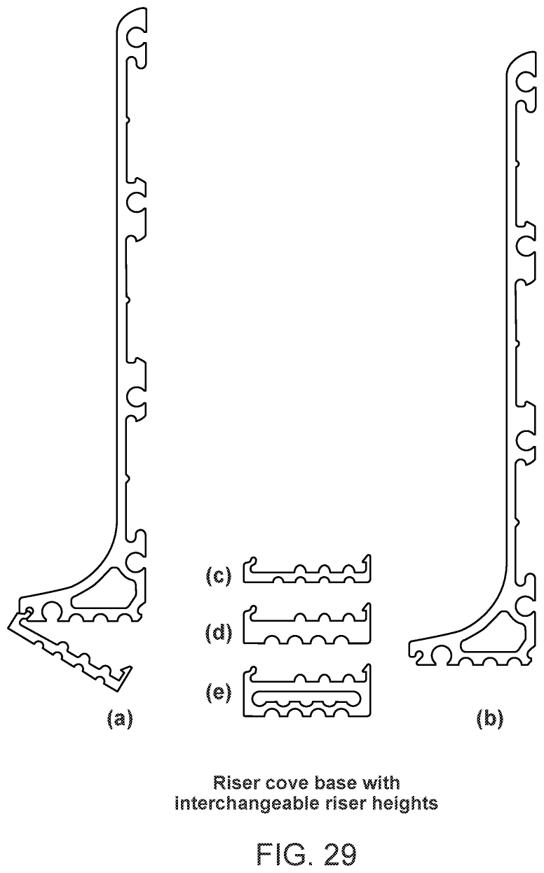

FIGS. 29(a)-(e) illustrate riser cove bases with interchangeable riser heights. That is, as shown in FIG. 29(a), the lower element (which interfaces with the floor) can be removed and replaced with an element having a greater or lower vertical height using a hinged snap feature or a typical snap/joining feature.

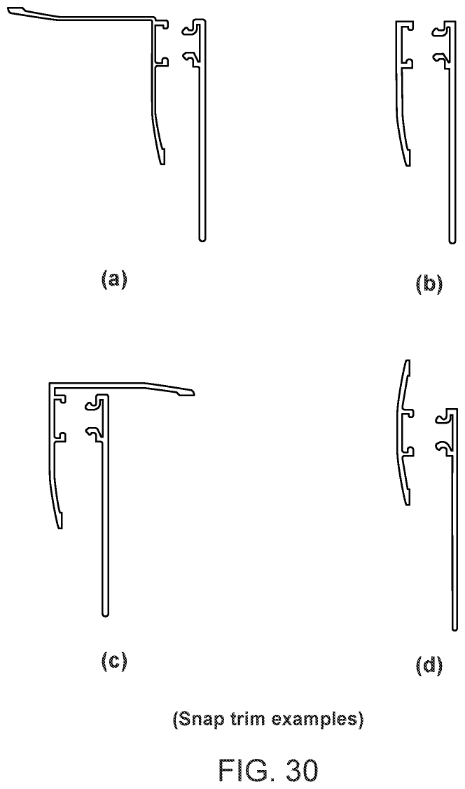

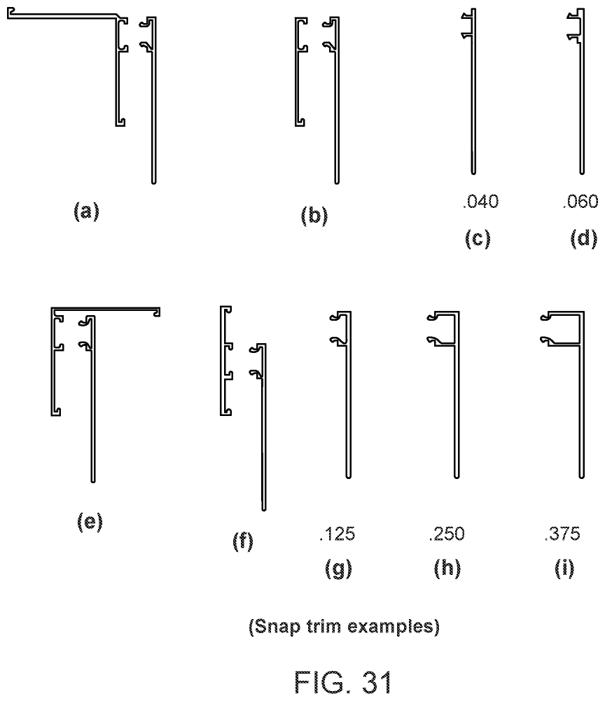

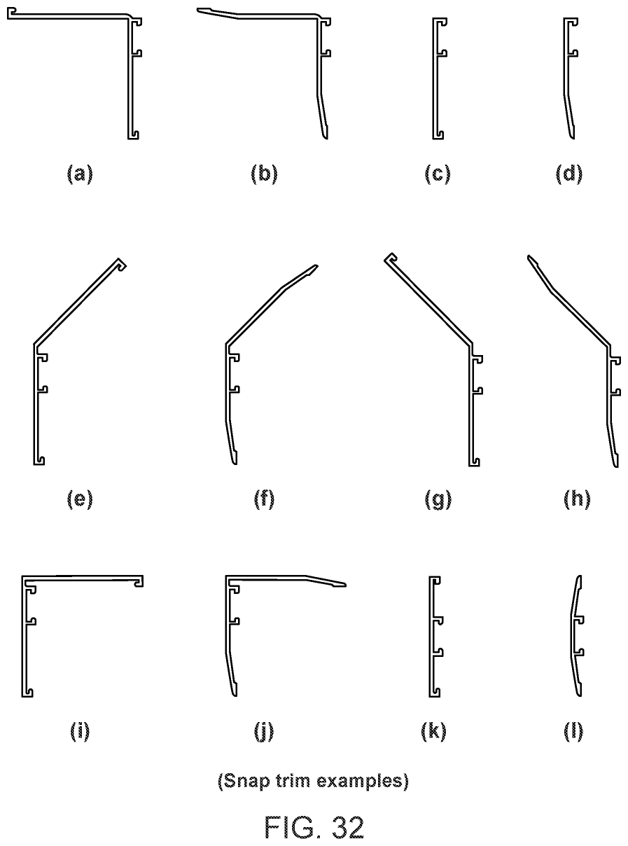

FIGS. 30(a)-(d), 31(a)-(i), 32(a)-(1) illustrate a variety of snap trim features and examples having a range of shapes, sizes, and configurations. As illustrated in FIGS. 30(a)-(d) and FIGS. 31(a), 31(b), 31(e), and 31(f), the snap trim components include mating pairs of projections that interlock in such a way that the components are held tightly together, but can be removed easily by deforming one of the components and separating them as shown. The components may configured with a specified offset distance (as shown in FIGS. 31(c)-(d) and FIGS. 31(g)-(i)) to set the trim the desired distance from a vertical surface (in these examples, 0.04, 0.06, 0.125, 0.250, and 0.375 inches). As shown in FIG. 32(a)-(1), the snap trim components may have a variety of shapes and sizes, depending upon the desired application. It will be appreciated that the configurations shown in FIGS. 30, 31, and 32 are not intended to limit the scope of the invention.

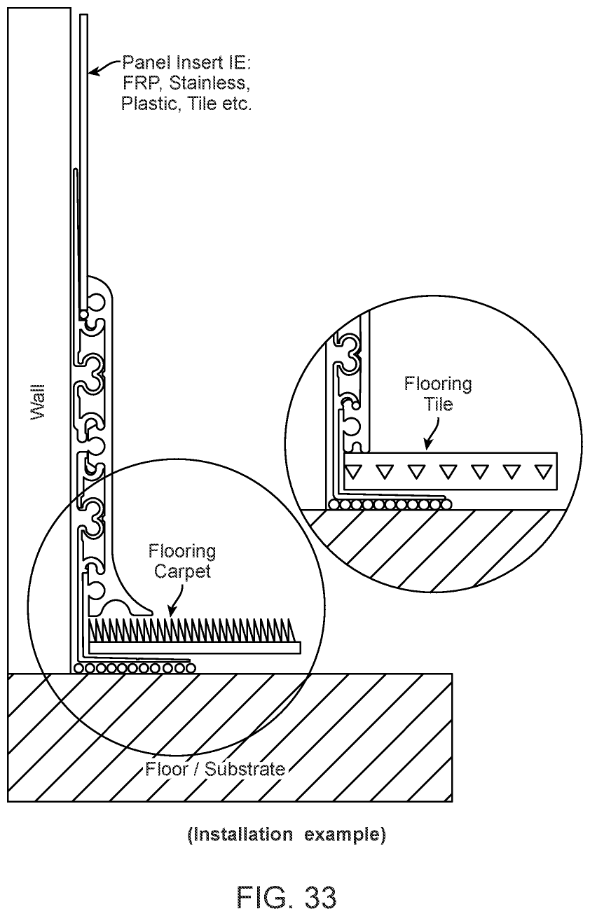

FIG. 33 presents another installation example (i.e., in contrast to FIG. 15) in which flooring such as carpet or tile is coupled to the floor/substrate. In this example, a lower flange interconnect (as shown in FIG. 13) is incorporated between the flooring material and the substrate, and the lower surface of the flange is attached to the substrate via an adhesive, as shown. Similarly, a vertical panel (e.g., FRP, stainless steel, plastic, tile, etc.) is inserted into the top of an upper flange interconnect. It will be appreciated that this configuration provides a very effective seal between any contaminants and the wall/substrate while still allowing a flooring material to be used.

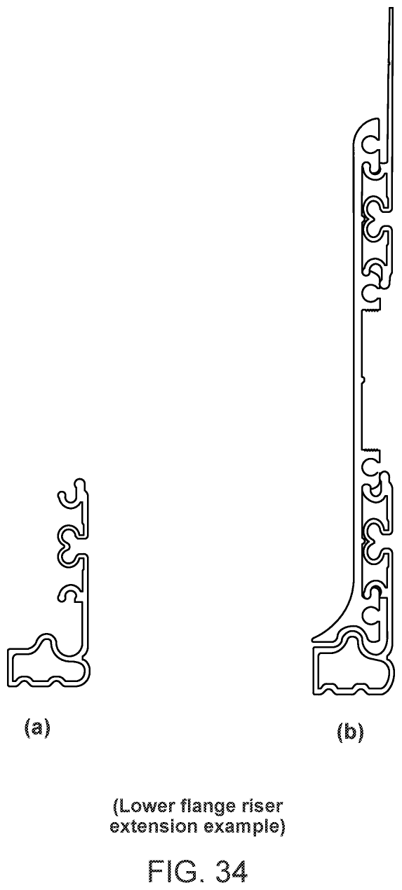

FIGS. 34(a) and (b) illustrate the use of a lower flange riser extension having a variety of vertical heights in accordance with one cove base example. That is, FIG. 34(a) illustrates an example extension including a bottom portion and an upper portion including an interconnect design as described previously. The shape of the bottom portion is configured to accept and mate with a corresponding element (e.g., a baseboard element as shown).

It will be appreciated by those skilled in the art that “flanges” are merely interchangeable profiles, and are not necessarily directionally oriented or location-specific. For example, an upper flange (FIG. 12(a)) may be inverted to be used in the lower section of a corresponding element (e.g., FIG. 4(d)(e)) stackable sections. Just as an upper flange can be inverted, the lower flange (FIG. 14(c)) can also be inverted into the upper element keyway section (FIG. 1, reference numeral 102), mid flange backer extensions (FIG. 11(b)) and can be located in either or both element keyway sections (FIG. 1, reference numerals 101 and 102) as needed per application.

As mentioned previously above, the various elements described herein may be used in conjunction with a variety of dimensional materials, including, without limitation, wall coverings such as wallpaper, plastics, metals, glass, FRP, stainless steel, honeycombed panels, tile, solid surface materials, planking, boards, drywall and any other commonly used architectural elements, as well as and floor coverings, such as vinyl flooring, VCT, tile, granite, marble, wood, carpet, concrete, epoxy, metal or fiberglass grating, and the like. The components and inserts described herein may be formed using any desired manufacturing technique and a wide range of materials, for example: extruded, pultruded, injected, die-cast, or molded forms comprising one or more of: aluminum, plastics, vinyl, ABS, PVC, FRP, and composites. The profiles, inserts, and other components described herein may be formed with a variety of finishes, including, without limitation: natural, colored, anodized, powder coated, gel coated, liquid paint, sublimated, filmed, brushed stainless, and the like.

In summary, what has been described are modular systems and methods for construction elements including a variety of “profiles” and associated interchangeable inserts. In addition, the present invention contemplates kits, manufacturing methods, packaging, and distribution methods for the disclosed elements and interconnects.

In addition, those skilled in the art will appreciate that embodiments of the present disclosure are unique in nature but may be practiced in conjunction with any number of current or future systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships, designs, profiles or physical connections may be present in an embodiment of the present disclosure.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A construction element system comprising:
a construction element body configured to transition between a first surface and a second surface having a defined intersection thereby, wherein the construction element body includes at least one flanged insertable-receiving area and a surface profile; and
at least one interchangeable insert configured to removably interface with the flanged insertable-receiving area of the construction element body.

2. The construction element system of claim 1, wherein the construction element body comprises dimensional material formed at a predetermined length.

3. The construction element system of claim 2, wherein the construction element body comprises at least two discrete sections of dimensional material longitudinally joined at their respective ends.

4. The construction element of claim 3, wherein the sections are joined by longitudinal pins inserted within pin openings provided at the respective ends.

5. The construction element system of claim 1, wherein the transition between the first surface and the second surface is selected from the group consisting of horizontal-to-horizontal transitions, horizontal-to-vertical transitions, vertical-to-vertical transitions, and vertical-to-horizontal transitions.

6. The construction element system of claim 1, wherein the surface profile is selected from the group consisting of baseboards, chair rails, crown moldings, corner guards, end-caps, bumper rails, door frame components, window frame components, pass-throughs, hand-rails, architectural and transitional elements, chases, and security enclosures.

7. The construction element system of claim 1, further comprising a back component configured to be securely coupled to the first surface and removably coupled via an interconnect structure to the flange insertable-receiving area of the construction element body.

8. The construction element system of claim 5, wherein the interconnect structure includes a first projection and a second projection, each configured to be elastically deformed and inserted into a receiving keyway incorporated into the flanged insertable-receiving area.

9. The construction element system of claim 5, wherein the interconnect structure includes a single cleat projection configured to be inserted into a receiving keyway incorporated into the flanged area.

10. The construction element system of claim 1, wherein the construction element body has a baseboard profile and has a flanged area comprising an upper keyway, a lower keyway, and a multi-use area provided therebetween.

11. The construction element system of claim 10, further including a first back component configured to be securely coupled to the first surface and removably coupled via an interconnect structure to the upper keyway, and a second back component configured to be securely coupled to the first surface and removably coupled via a second interconnect structure to the lower keyway.

12. The construction element system of claim 11, wherein each of the interconnect structures includes a first projection and a second projection, each configured to be elastically deformed and inserted into the corresponding keyway.

13. The construction element system of claim 12, wherein the construction element body comprises at least two discrete sections of dimensional material longitudinally joined at their respective ends.

14. The construction element system of claim 10, further including a chase component configured to seat within the multi-use area.

15. The construction element system of claim 10, wherein the profile includes a cove base configured to be secured to the first surface via an adhesive.

16. The construction element system of claim 8, wherein the back component includes a lower projection configured to hingedly accept an interlocking secondary component.

17. The construction element system of claim 1, further including one or more interchangeable riser component configured to attach to the construction element body at the interface of at least one of the first and second surfaces.

18. A method of assembling construction elements comprising:
forming a construction element body configured to transition between a first surface and a second surface having a defined intersection thereby, wherein the construction element body includes at least one flanged insertable-receiving area and a surface profile; and
providing at least one interchangeable insert configured to removably interface with the flanged insertable-receiving area of the construction element body; and
fixing the interchangeable insert to the flanged insertable-receiving area.

19. The method of claim 18, wherein forming the construction element body includes forming the body from dimensional material.

20. The method of claim 19, wherein the construction element body is formed from at least two discrete sections of dimensional material longitudinally joined at their respective ends.
